(19) United States
(12) Patent Application Publication
(10) Pub. No.: US 2006/0178863 A1
(43) Pub. Date: Aug. 10, 2006

(54) Combining and representing signals of a hardware simulation device and elements of a program listing

(75) Inventors: Axel Andersch, Numberg (DE); Michael Klier, Gebenbach (DE); Wolfgang Mandl, Kummersbruck (DE); Wolfgang Sehr, Hirschau (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELI SCHAFT, Muncheh (DE)

(21) Appl. No.: 10/562,303

(22) PCT Filed: May 10, 2004
(86) PCT No.: PCT/EP04/04991

§ 371 Date: Dec. 22, 2005

(30) Foreign Application Priority Data
Jun. 27, 2003 (DE) 103 29 147.4

(51) Int. Cl. G06F 17/50

(52) U.S. Cl. 703/14

(57) ABSTRACT

The invention relates to a system and a method for combining and representing signals of a hardware simulation device and elements of a program listing, and an error locating tool. In order to be able to jointly represent the signals of the hardware simulation device and the elements of the program listing, the hardware simulation device simulates the behavior of a circuit comprising a processor, a program memory that contains the program code, and application-specific hardware components and generates signals as a result of said simulation, the elements of the program listing are combined with the signals generated during the simulated execution of the program codes which are contained in the program memory and correspond to said elements, and the elements of the program listing can be represented in a first partial area of a graphic display means while the signals can be represented in a second partial area of the display means.

### CROSS REFERENCE TO RELATED APPLICATIONS

This application claims priority to the German application No. 10329147.4, filed Jun. 27, 2003 and to the International Application No. PCT/EP2004/004991, filed May 10, 2004 which are incorporated by reference herein in their entirety.

### FIELD OF INVENTION

The invention relates to a system as well as to a method for combining and representing signals of a hardware simulation device as well as to an error locating tool.

### BACKGROUND OF INVENTION

A hardware-software cosimulator for simulation of a hardware-software system is known from U.S. Pat. No. 5,768,567 which features a logical simulator, bus interface models, instruction set simulators and what is known as a simulation optimization manager. The simultaneous simulation of hardware and software is also called cosimulation. In this case the cosimulation is executed with a single coherent view of the memory of the hardware-software system which is kept transparent both for hardware and for software by the cosimulation optimization manager.

An object of the invention is to allow the common presentation of signals of a hardware simulation device and elements of a program listing.

### SUMMARY OF INVENTION

This object is achieved by a system for combining and representing signals of a hardware simulation device and elements of a program listing,

with the hardware simulation device simulating the behavior of a circuit with a processor, a program memory which contains the program code of the program and application-specific hardware components and creating signals as a result of the simulation,

with the elements of the program listing being combined with the signals created by the simulated execution of the program code contained in the program memory corresponding to these elements,

with the elements of the program listing being able to be represented in a first subarea of a graphical display means and the signals in a second subarea of the display means.

This object is achieved by a method for combining and presenting signals of a hardware simulation device and elements of a program listing,

with the hardware simulation device simulating the behavior of a circuit with a processor, a program memory containing the program code of the program and application-specific hardware components and creating signals as a result of the simulation,

with the elements of the program listing being combined with the signals created by the simulated execution of the program code contained in the program memory corresponding to these elements,

with the elements of the program listing being represented in a first subarea of a graphical display means and the signals in a second subarea of the display means.

This object is achieved by an error locating tool for combining and representing signals of a hardware simulation device and elements of a program listing,

with the hardware simulation device simulating the behavior of a circuit with a processor, a program memory containing the program code of the program and application-specific hardware components, and creating signals as a result of the simulation,

with the error locating tool featuring means for combining the elements of the program listing with the signals created in the simulated execution of the program code contained in the program memory corresponding to these elements,

with the elements of the program listing being able to be represented in a first subarea of a graphical display means and the signals in a second subarea of the display means.

The invention is based on the knowledge that the design of hardware-software systems is significantly simplified by a combined representation of the signals of a hardware simulator and the elements of a program listing. The inventive system and method allows a simple and fault-tolerant tracing of the execution of a program. The representation of the program listing establishes a direct link to the actual program, in particular because the list file is used the comments inserted into the original source text can be shown. The presence of an abstracted software model of the processor is not necessary for combining and representing the signals of the hardware simulation device. This guarantees that the processor actually used in the circuit is simulated. An error caused by describing the processor by means of a model is thus excluded from the simulation. The program sequence is visualized in a similar form to that used by normal development tools for debugging pure software. The familiarization time for users of the system or of the method who have experience in the development of software or firmware is thus relatively small.

In accordance with an advantageous embodiment of the invention there is provision for marking an element of the program listing in the first subarea of the graphical display means and for marking the signals combined with this element in the second subarea of the display means. The graphical representation is thus oriented to normal software debug tools. The program sequence can be traced through a marking of an element of the program listing. In the second subarea of the display means a marking synchronized to the marking in the first subarea of the display means moves, so that cross references can be recorded for the remaining hardware.

Advantageously a third subarea of the graphical display means is provided for representation of at least a part of the signals, especially further values. Further values can be register values for example.

The use of a normal devices for hardware simulation is simplified when, in accordance with an advantageous embodiment of the invention, the circuit with the processor, the program memory and the application-specific hardware components are described in a hardware description language.

The system can be adapted with little effort to different processors, if in accordance with an advantageous embodiment of the invention means are provided for adapting the system to different processor types.

### BRIEF DESCRIPTION OF THE DRAWINGS

The invention is described and explained in more detail below on the basis of the exemplary embodiments shown in the figures.

The figures show:

FIG. 1 a schematic diagram of a system for combining and representing signals of a hardware simulation device and elements of a program listing,

FIG. 2 a section of a presentation of signals of a hardware simulation device and

FIG. 3 a representation of signals of a hardware simulation device and elements of a program listing.

### DETAILED DESCRIPTION OF INVENTION

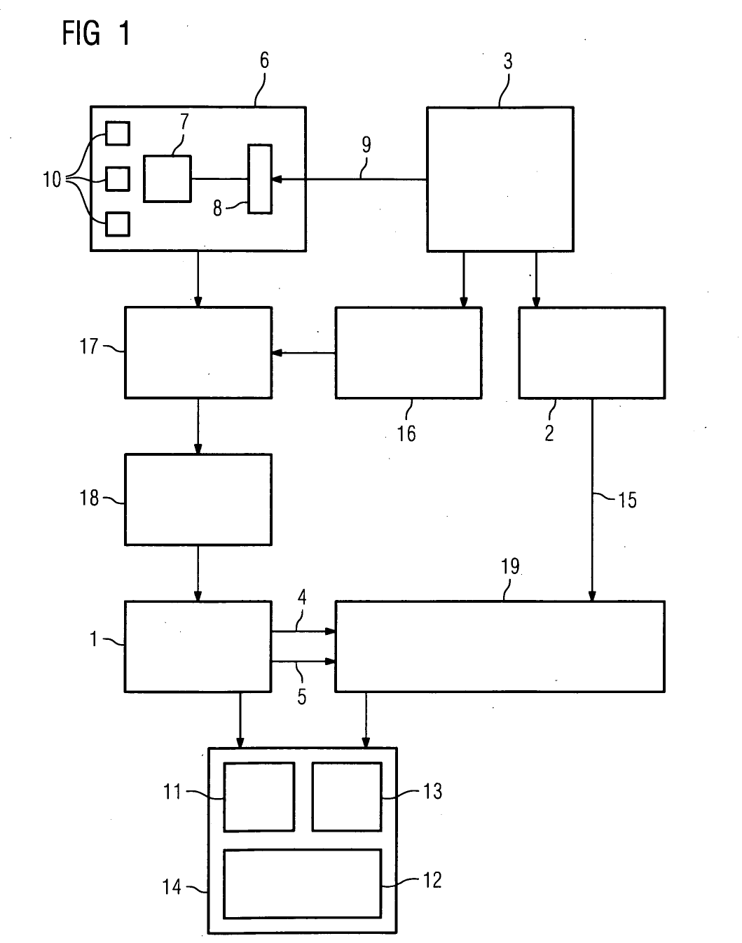

FIG. 1 shows a schematic diagram of a system for combining and representing signals 4, 5 of a hardware simulation device 1 and elements 15 of a listing 2 of a program 3. The hardware simulation device 1 simulates the behavior of a circuit 6 with a processor 7, program memory 8 and application-specific hardware components 10. The processor 7 can for example be a microprocessor or microcontroller. The program memory 8 contains the program code 9 of the program 3. The circuit 6 is described with the aid of a Hardware Description Language (abbreviated to HDL), in the exemplary embodiment by means of VHDL (VHDL=Very High Speed Integrated Circuit Hardware Description Language). The source code in VHDL is indicated by the symbol 17. The hardware simulation device 1 is accordingly also referred to as an HDL simulator. An example of an HDL simulator is the “ModelSim” product from Model Technology, Portland, Oreg., USA. The circuit 6 is for example an ASIC (ASIC=Application Specific Integrated Circuit). The HDL source code 17 is converted with a suitable compiler into an HDL simulator format 18 which can be processed by the hardware simulation device 1. The hardware simulation device 1 creates signals 4, 5 as the result of the simulation. The program 3, or the program code 9 of the program 3 is converted by means of a compiler into a data file 16 (usually with data in hexadecimal) and a listing 2, also known as a list file. The listing 2 contains both the program commands and also the associated comments. The listing 2 is created line by line, with each line containing a program command or an instruction, where necessary with the associated comment. A line, a program command, an instruction or a comment are elements 15 of the listing 2. A debugger 19 combines the elements 15 of the listing 2 of the program 3 with the signals 4, 5 created in the simulated execution of the program code 9 contained in the program memory 8 corresponding to these elements 15. The elements 15 of the listing 2 of the program 3 are displayed in a first partial area 11 of the graphical display means 14 and the signals 4, 5 in a second partial area 12 or in a third partial area 13 of the display means 14.

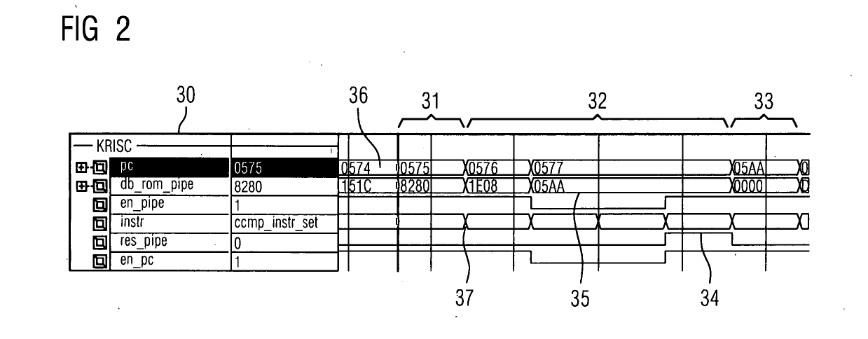

FIG. 2 shows of a section 30 of a representation of signals 4, 5 of a hardware simulation device 1. The signals 4, 5 are shown as waveforms 35, 36 and 37.

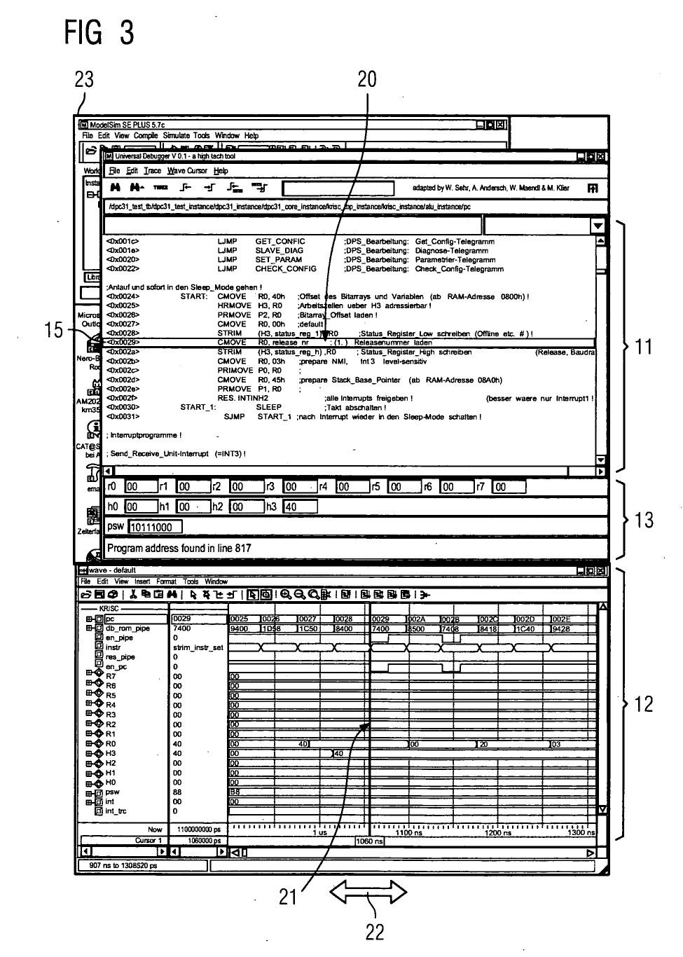

FIG. 3 shows a representation 23 of signals 4, 5 of a hardware simulation device 1 and elements 15 of a listing 2 of a program 3. The elements 15 of the listing 2 are displayed in a first partial area 11, the signals 4, 5 in a second 12 or of a third 13 partial area of a display means 14. The elements 15 can be provided with a marking 20, e.g. a colored highlight. The signals 4 can be provided with a marking 21, e.g. a cursor. A display means 14 can be a screen surface, the partial areas 11 to 13 can be implemented as display windows. The sequence of the program 3 in the processor 7 (see FIG. 1) is visualized with the aid of the graphical frontend, of the debugger 19, which is based on the signals 4, 5 of the hardware simulation device 1. The process visualization of the program sequence is undertaken by accessing signals of the processor 7, for which the values are calculated by the hardware simulation device 1.

In accordance with the exemplary embodiment the debugger 19 is implemented in the script language TCL/TK (TCL/TK=Tool Command Language/Toolkit) and uses the TCL/radio interface to HDL objects, which makes an HDL simulator available. Such HDL objects can be represented as waveforms for example. To design the debugger 19 to be as flexible as possible, i.e. in this context to enable it to be adapted relatively easily to different processors, the debugger 19 is subdivided into two sections. A first general part provides procedures for process visualization. A second processor-specific part is adapted to the processor concerned and is made up of the following procedures for example:
Procedures for single step right/left
Procedures for determining the register values
Procedures for the coupling of signals and elements of the listing
Procedure for configuration

In the procedures for single step right/left (reference symbol 22 in FIG. 3) the cursor in a waveform window is set to the next valid command. For the example of a KRISC8 processor (KRIS=Kommunikations-RISC 8 Bit, Spezial-Core for the communication in field bus system from Siemens AG, Munich, Germany) this is illustrated in FIG. 2.

The section from a listing reproduced below shows a procedure for single step right.

# procedure for Single-Step-Right

| | |
|---|---|
| #N.B. | pc must be selected in the Wave window (the right command operates on the |
| # | selected signal)!!!!! |

```
proc right krisc8.Proc { } {
  global minideb
  global DEBUG
  set time_now [lindex [getactivecursortime] 0]
  set address [examine -time $time_now $minideb(TIME UNIT) -hex $minideb(pc-path)]
  set address,tmp [examine -time [expr $time_now + $minideb(CLK PERIOD)] $minideb(TIME UNIT)
  -hex
$minideb(pc-path)]
  set I 1
  if {$DEBUG == “on”) {echo “start of right.Proc”}
  if {$address_tmp == “No Data”} {
    .mainFrame.label message configure -bg DimGray -fg red -text “end of simulation
    reached.”
    set minideb(cars step right) 0
    .mainFrame.frame_toolbar.autostep right configure-background grey -activebackground
    khaki2
    .mainFrame.frame_toolbar.label info configure -text “”
    return
  }
  # Look for start of next command
  while {$address == $address_tmp} {
    if {$DEBUG == “on”} {echo “right.Proc: whileSchleife 1”)
    incr I
    set address_tmp [examine -time [expr $time_now + $I * $minideb(CLK PERIOD)]
    $minideb(TIME UNIT)
-hex $minideb(pc-path))
  }
  set time_now [expr $time_now + $I * $minideb(CLK PERIOD)]
  if ($DEBUG == “on”) {echo “right. Proc:time_now--> $time_now”)
  set schleife 1
  # Look for the next valid command
  while {$schleife == 1) {
    if ($DEBUG == “on”) (echo “right.Proc: while-Schleife 2”)
    # Look for the end of the command
    set address [examine -time $time, now $minideb(TIME UNIT) -hex $minideb(pc-path)]
    set address_tmp [examine -time [expr $time_now + $minideb(CLK PERIOD)] $minideb(TIME
    UNIT) -hex
$minideb(pc-path)]
    if {$address_tmp == “No Data”} {
    .mainFrame.label message configure -bg DimGray -fg red -text “End of simulation
    reached.” set minideb(auto_step_right) 0
    .mainFrame.frame_toolbar.autostep_right configure-background grey -activebackground
    khaki2 .mainFrame.frame_toolbar.label info configure -text “”
    return
  }
  set I 1
  while {$address == $address_tmp} {
    if {$DEBUG == “on”} (echo “right.Proc: whileSchleife 3”}
    incr I
    set address_tmp (examine -time [expr $time_now + $I * $minideb(CLK PERIOD)]
$minideb(TIME UNIT) -hex $minideb(pc-path)]
  }
  set time_now_tmp [expr $time_now + $I * $minideb(CLK PERIOD)]
  # command is 16 bits wide?
  set instruction [examine -time $time_now $minideb(TIME UNIT) -hex $minideb(instruction)]
  set digit [split $instruction “”]
  set kl “[lindex $digit 0][lindex $digit 1]”
  if {$DEBUG == “on”} (echo “right.Proc: splitted instruction--> <$kl>”}
  if {$kl == “lE”} {
    # command is 16 bits wide, move forward 1 command
    if {$DEBUG == “on”) (echo “right.Proc: 16-bit command”)
    set time-now $time_now_tmp
  } else {
    set read time [expr $time_now trap − 0.5 * $minideb(CLK PERIOD)]
    if {$DEBUG == “on”) (echo “right.Proc:time_now--> $time, now; time_now_tmp -->
$time_now_tmp; read time --> $read_time”}
    if {$DEBUG == “on”) [echo “en pipe --> [examine -time $read_time $minideb(TIME UNIT)
-bin $minideb(en pipe)]; \
        res-pipe --> [expr ![examine -time $read_time
        $minideb(TIME_UNIT)
-bin $minideb(res_pipe))]”)
    if ([examine -time $read_time $minideb(TIME UNIT) -bin $minideb(en pipe)] && !(examine -
time $read_time $minideb(TIME UNIT) -bin $minideb(res_pipe)]} {
        # next valid command found
        set schleife 0
      } else [
        if {$DEBUG == “on”) (echo “right.Proc: The command is invalid!”)
        # command is not executed since
        # - pipe enable is not set
        # - pipe reset is set
        # go on 1 command set time_now $time_now_tmp
      }
    }
  }
  set address_int [examine -time $time_now $minideb(TIME,UNIT) -hex $minideb(pc-path)] if
  ([catch {.$minideb(wave_name).tree right -value ‘h$address int 1} result] !=0} {
    # if PC is not marked deactivate auto step and display an error message
    set minideb(cars step right) 0
    .mainFrame.frame_toolbar.autostep right configure-background grey -activebackground
    khaki2 .mainFrame.frame_toolbar.label info configure-text “”
    notice show “$result \nPlease select pc in the wave-Window!”
  }
  trace.Proc
}
```

The simplified procedure in this case is as follows (see FIG. 2):

At the current simulation time the value of the program counter 36 (pc=program counter) is determined. The currently executed command is identified in FIG. 2 by the reference symbol 31)

The beginning of the next commands is looked for. The cursor is advanced by a multiple of the clock period until a change in the program counter occurs.

A check is made as to whether the command now reached is executed.

If a command which will not be executed is involved, the command after next is tested (repeated until such time as an executed command is reached or the end of the simulation is reached). In the example shown in FIG. 2 the not yet executed, i.e. invalid commands are identified by the reference symbol 32.

If the command reached is executed, the cursor is placed in the Waveform window (corresponds to the second partial area 12 of the display means 14 as shown in FIG. 3) at this point in time. In the example shown in FIG. 2 the next executed, i.e. valid command, is identified by the reference symbol 33.

The valid command is determined on a processor-specific basis. It is not usually sufficient with modern processor architectures to follow the program counter 36, instead additional signals 4, 5 are to be evaluated which specify whether the current command is valid (e.g. the signal underlying the waveform 34). If a valid command was determined, the marking 20 of the currently executed command in the displayed listing is undertaken in the first partial area 11 of the display means 14 and the register values are shown in the third partial area 13 of the display means 14 (see section of a listing given below).

```
proc trace.Proc { } {
  global progadr alt
  global minideb
  global DEBUG
  if {$minideb(configure done) == 1} {
    if {$minideb(cursor move enable) _= 1}{
    DisableCursorMove.Proc
    }
    # Read Out program counter
    set timenow [lindex [getactivecursortimel 0]
    # Read current program address
    if ($DEBUG == “on”} {echo “trace.Proc: timenow read in”}
    set progadr  [string follower [examine -time $timenow $minideb(TIME UNIT) -hex
$minideb(pcpath)]]
    if ($DEBUG == “on”} {echo “trace.Proc: progadr gelesen <$progadr>”} # Program address is
    undefined (start of the simulation) ? if {![rules {[θ9a-fA-F]+} $progadr]} {
    set progadr 0
    # Multiply program counter read by 2 to obtain the program address (for NIOS) # leading
    zeros are truncated
    # since hex characters cannot be used for calculation, the system converts to a decimal
    character,
    # the result is multiplied by 2 (with NIOS, 1 with KRISC) and subsequently converted
    back into a # hex number.
```

| | |
|---|---|
| set progadr int | [hex2int $progadrj |
| set progadr_int | [expr $minideb(addressmultiplikator)*$progadr int] |
| set progadr | [int2hex $progadr intJ |

```
    SearchCodeLine.Proc $progadr
    GetRegisterValues $minideb( ).Proc
    set program alt $progadr
  } else {
    bell
    .mainFrame.label message configure -bg DimGray -fg red -text “Before tracing you have to
  configure the program.”
  ]
}
```

There were not previously any satisfactory options for following the simulated sequence of a program 3 on a processor 7. The manual tracing of the program sequence on the basis of a waveform output by a simulator and the printout of a list file has the disadvantage that, with the processors usually used (pipelines, caches, etc.) tracing the program requires a great deal of effort and is subject to errors. To trace the program execution sequence based on a disassembler printout a user does not have to perform any direct evaluation of the waveform. Only a list of the commands processed by the processor is output. However this means that there is no direct reference to the actual program and thus the comments inserted into the source text are not shown. When a debugger based on an abstracted C model is used, two disadvantages are essentially produced. One is that a C model is needed for the processor used, which is normally not available and thus requires effort to create. The other is that the C model of the processor represents a new description of the processor and it is not inconceivable that the actual process behaves in a way which deviates from its behavior in the C model. Since for the method proposed here no model is needed for the processor 7, it is guaranteed on the one hand that the same processor 7 is simulated which is also implemented in the circuit 6. On the other hand the effort involved in adapting the debugger 19 to different processors 7 or processor types is kept within limits.

In summary the invention thus relates to a system and a method for combining and representing signals 4, 5 of a hardware simulation device 1 and elements 15 of a listing 2 of a program 3 as well as to an error locating tool. To allow a common representation of the signals of the hardware simulation device and the elements of the program listing, it is proposed that the hardware simulation device 1 simulates the behavior of a circuit 6 with a processor 7, a program memory 8 which contains the program code 9 of the program 3, and application-specific hardware components 10, and creates signals 5 as the result of the simulation, that the elements 15 of the listing 2 of the program 3 are combined with the signals 4, 5 created during the simulated execution of the program code 9 contained in the program memory 8 corresponding to these elements 15 and that the elements 15 of the listing 2 of the program 3 can be represented in a first partial area 11 of a graphical display means 14 and the signals 5 in a second partial area 12 of the display means 14.

The technical background of the invention and the terms used are explained in greater detail below.

The circuits described are for example used in what are referred to as embedded systems. Examples of programming languages for use in embedded systems are C, Assembler, C++ and Java. Common to these languages is the use of a compiler which prescribes a step-by-step method of code development, known as the edit-compile-load-debug cycle. Error locating tools called debuggers are generally employed to trace errors in the software programming. Since most software developments systems provide an integrated development environment for this purpose, debuggers can modify the program code relatively simply and check it with single steps or checkpoints set on their target system. A program can be executed in a controlled manner in this way, meaning that the program can be executed line-by-line and the values of variables requested and changed. Software debuggers provide the following basic functions:

Single-step execution of Assembler and high-level language code

Networks of breakpoints at defined points in the high-level language or machine code, at which the program is stopped temporarily

Display of variable values, logical expressions, memory addresses and CPU registers

TCL is a cross-platform script programming language. TCL is optimized for this purpose by the combination of text processing, file processing and system control functions. EDA tools (EDA=Electronic Design Automation) frequently use TCL in conjunction with the graphic toolkit TK to provide a flexible and platform-independent graphical user interface. This includes ModelSim for example.

In the area of embedded systems the parallel design of hardware and software has largely replaced the classical, purely sequential design sequence. Embedded systems play a dominating part in automation technology. Their success is based on the exponentially increasing complexity of integrated circuits and thus the growing opportunities for new system functions which are increasingly implemented in software. The resulting system complexity demands a stochastic increase in design productivity with simultaneously falling development times. This increase can only be achieved by design automation and systematic reuse of system functions. A significant step is the Integration of hardware and software design, hardware/software codesign.

Hardware and software design often begin before the completion of the system architecture or even before the finalization of the specification. System architects, users and customers or marketing experts jointly develop requirement definition and specification. The system architect develops from this a system of cooperating system functions as a basis for a subsequent parallel design of hardware and software. The outline architecture of the target hardware is also developed at this point. The hardware-/software interface design requires the participation of hardware and software developers. The integration of the hardware and software components and the testing of the integrated system follows as the last step. In all phases deviations from the expected design results or requirements of the specification lead to a repeat of the design steps. A central problem in the design process is the monitoring and integration of the parallel hardware and software design. An early error detection requires consistency and correctness checking which requires a level of effort concomitant with the level of design detail.

For hardware-software cosimulation the execution of the software on the (processor) hardware is simulated together with application-specific hardware components. Since a simulation with a high level of detailing, as is usual in hardware design, is too slow for a practically usable hardware simulation, abstract process models are usually needed. For this purpose the processors are modeled more abstractly (“at a higher level of abstraction”) than other hardware components. In this case the timing behavior of the processor is no longer shown precisely matched to the clock, i.e. encoded for each clock cycle, but only the program with its inputs and outputs. The problem of cosimulation now lies in the coupling of the different abstract models such that sufficient accuracy of the simulation is achieved. In the worst case processors and other hardware components are accessing the same memory. A more precise modelling demands in this case adapted memory and bus models and specific simulation techniques. An example of this is provided by the cosimulator Seamless CVS from Mentor Graphics, Wilsonville, Oreg., USA. The product Seamless CVS uses an abstract processor model which simulates command execution (known as an Instruction Set Simulator). Bus models are used for memory access, for which the abstraction depends on simultaneous access to processor and hardware. Memories to which only one processor has access, are consequently modelled in a more abstract way than those in which conflicts can arise. The availability of a library of models which are obtained from the CAD provider of the processor manufacturer is thus required.

An abstract approach reduces the processor model to the pure program execution on the PC or the workstation and merely models the Interface with runtime behavior. The coupling of the software execution to the hardware model is then undertaken via a simulator-specific communication protocol which the developer of the software must insert. Only Interface models are required for this modelling, which significantly simplifies the problem of libraries. On the other hand the runtime behavior is only modeled correctly on the hardware side. An example of this type of cosimulator is the product called Eagle from Synopsys, Mountain View, Calif., USA.

1.-11. (canceled)

12. A system for combining and representing signals of a hardware simulation device and elements of a listing of a software program, comprising:
a graphical display;
a software program;
a listing of the software program having listing elements; and
a hardware simulation device configured to:
simulate a behavior of a circuit having:
a processor;
a program memory including a program code of the software program; and
application-specific hardware components; and
create signals during a simulated execution of the program code included in the program memory, the program code corresponding to the listing elements, the signals representing a result of the hardware simulation, wherein the system is programmed and configured to:
interrelate the listing elements with the signals;
display the listing elements in a first partial area of the graphical display; and
display the signals in a second partial area of the graphical display.

13. The system in accordance with claim 12, further comprising a marking unit for marking at least one of the listing elements in the first partial area and for marking such signals interrelated with the at least one marked listing element in the second partial area.

14. The system in accordance with claim 12, wherein the graphical display comprises a third partial area for representing at least a part of the signals.

15. The system in accordance with claim 12, wherein the circuit is described in a hardware description language.

16. The system in accordance with claim 12, further comprising an adapting unit for adapting the system to different processor types.

17. A method of combining and presenting signals of a hardware simulation device and elements of a listing of a software program, comprising:
simulating a behavior of a circuit having:
a processor;
a program memory including a program code of the software program; and
application-specific hardware components, by a hardware simulation device;
creating signals during a simulated execution of the program code included in the program memory, the program code corresponding to the listing elements, the signals representing a result of the hardware simulation, by the hardware simulation device;
interrelating the listing elements with the signals;
displaying the listing elements in a first partial area of a graphical display; and
displaying the signals in a second partial area of the graphical display.

18. The method in accordance with claim 17, further comprising:
marking at least one of the listing elements in the first partial area; and
marking such signals interrelated with the at least one marked listing element in the second partial area.

19. The method in accordance with claim 17, further comprising displaying at least a part of the signals in comprises a third partial area of the graphical display.

20. The method in accordance with claim 17, wherein the circuit is described in a hardware description language.

21. The method in accordance with claim 20, further comprising adapting such hardware description language corresponding to the processor to represent a different processor type.

22. An error locating tool for combining and representing signals of a hardware simulation device and elements of a listing of a software program, the hardware simulation device configured to simulate a behavior of a circuit with a processor, with a program memory having a program code of the software program, and with application-specific hardware components, and the hardware simulation device further configured to create signals as a result of a simulation, the error locating tool comprising:
an analysis unit for interrelating the elements of the listing with the signals created during a simulated execution of the program code, the program code corresponding to the elements; and
a graphical display for displaying the elements in a first partial area of the graphical display and for displaying the signals interrelated with the elements in a second partial area of the graphical display.
